(19) United States
(12) Patent Application Publication
(10) Pub. No.: US 2013/0067413 A1
(43) Pub. Date: Mar. 14, 2013

(54) Control of Information Technology Resource Behavior Using Visual Positioning

(71) Applicants: Gregory J. Boss, Saginaw, MI (US); Andrew R. Jones, Round Rock, TX (US); Charles S. Lingafelt, Durham, NC (US); Kevin C. McConnell, Austin, TX (US); John Moore, Brownsburg, IN (US)

(72) Inventors: Gregory J. Boss, Saginaw, MI (US); Andrew R. Jones, Round Rock, TX (US); Charles S. Lingafelt, Durham, NC (US); Kevin C. McConnell, Austin, TX (US); John Moore, Brownsburg, IN (US)

(73) Assignee: International Business Machines Corporation, Armonk, NY (US)

(21) Appl. No.: 13/229,616

(22) Filed: Sep. 9, 2011

(51) Int. Cl. G06F 3/048

(52) U.S. Cl. 715/835

(57) ABSTRACT

An embodiment of the invention provides a method for controlling computing resources using visual positioning on a graphical user interface. More specifically, a computer resource is displayed as a symbol and applications are displayed as objects on the graphical user interface. Input is received from a user, wherein the input includes movement of the symbol and/or movement of at least one of the objects on the graphical user interface. The computer resource is allocated with a processor based on the input. This includes allocating more of the computer resource to a first application and less of the computer resource to a second application when the distance between the symbol and a first object representing the first application is reduced, and when the distance between the symbol and a second object representing the second application is increased.

### BACKGROUND

The present invention is in the field of systems, methods, and computer program products for the control of information technology (IT) resource behavior using visual positioning.

In the field of data processing systems and, more specifically, server systems, resource management software allows administrators to allocate CPU time to specific applications running under the server's operating system. The resource management software can allocate CPU cycles to applications such that, for example, high priority applications can be guaranteed a minimum percentage of CPU cycles. This type of resource management beneficially enables administrators to permit low priority applications to execute without substantially degrading the performance of high priority applications.

### SUMMARY OF THE INVENTION

An embodiment of the invention provides a method for controlling computing resources using visual positioning on a graphical user interface. More specifically, a computer resource is displayed as a symbol and applications are displayed as objects on the graphical user interface. Input is received from a user, wherein the input includes movement of the symbol and/or movement of at least one of the objects on the graphical user interface. The computer resource is allocated with a processor based on the input. This includes allocating more of the computer resource to a first application and less of the computer resource to a second application when the distance between the symbol and a first object representing the first application is reduced, and when the distance between the symbol and a second object representing the second application is increased.

Another embodiment of the invention provides a method for controlling computing resources, wherein a computer resource is displayed as a symbol and applications are displayed as objects on a graphical user interface. A text box is displayed when the symbol is positioned proximate one of the objects, wherein the text box includes computer resource allocation options for the object proximate the symbol. Input is received from a user, wherein the input includes selection of one of the computer resource allocation options. The computer resource is allocated with a processor based on the input from the user.

Yet another embodiment of the invention provides a method for controlling computing resources, wherein computer resources are displayed as symbols and applications are displayed as objects on a graphical user interface. Input is received from a user, wherein the input includes movement of a symbol and/or an object on the graphical user interface. The computer resources are allocated with a processor based on the input, including allocating more of a first computer resource to an application represented by an object when a distance between a symbol representing the first computer resource and the object is decreased. The processor also allocates less of a second computer resource to the application represented by the object when a distance between a symbol representing the second computer resource and the object is increased.

### BRIEF DESCRIPTION OF THE SEVERAL VIEWS OF THE DRAWINGS

The present invention is described with reference to the accompanying drawings. In the drawings, like reference numbers indicate identical or functionally similar elements.

FIG. 1 illustrates a graphical user interface display according to an embodiment of the invention;

FIG. 2 illustrates a graphical user interface display according to another embodiment of the invention;

FIG. 3 is a flow diagram illustrating a method for controlling computing resources according to another embodiment of the invention;

FIG. 4 is a flow diagram illustrating a method for controlling computing resources according to another embodiment of the invention;

FIG. 5 is a flow diagram illustrating a method for controlling computing resources according to yet another embodiment of the invention;

FIG. 6 illustrates a graphical user interface according to an embodiment of the invention;

FIG. 7 depicts a cloud computing node according to an embodiment of the present invention;

FIG. 8 depicts a cloud computing environment according to an embodiment of the present invention;

FIG. 9 depicts abstraction model layers according to an embodiment of the present invention; and

FIG. 10 illustrates a computer program product according to an embodiment of the invention.

### DETAILED DESCRIPTION

Exemplary, non-limiting, embodiments of the present invention are discussed in detail below. While specific configurations are discussed to provide a clear understanding, it should be understood that the disclosed configurations are provided for illustration purposes only. A person of ordinary skill in the art will recognize that other configurations may be used without departing from the spirit and scope of the invention.

An embodiment of the invention includes a graphical user interface (GUI) that directs the use of computer resources based upon a “center of the universe” concept. This concept allows for multiple resource allocation by users with technical expertise as well as users without a technical background. The graphical representation and control of information technology (IT) resources can be applied to software and appliance product lines, in which the administrator of the product has a need to adjust the product's use of resources, such as the proportion of CPU cycles used by an application. The graphical representation and control of IT resources (also referred to herein as “computer resources”) can also be applied to cloud offerings, in which the administrator and/or clients of the cloud has a need to adjust the consumption of cloud resource by consumers, e.g., applications, of the cloud. In at least one embodiment, IT resources include CPU cycles, memory allocation, and disk access.

The concept of “center of the universe” is a user interface that allows a user to position the “focus” of computer resources on certain parts of a computer display representing applications (also referred to herein as “jobs” or “tasks”) that are currently running on the system. In at least one embodiment, the focus is a symbol that can be positioned on or near other windows in windows-based operating systems. As the symbol nears an application or group of applications, the computer allocates or assigns more resources or computing priority to the application or group of applications nearest the symbol.

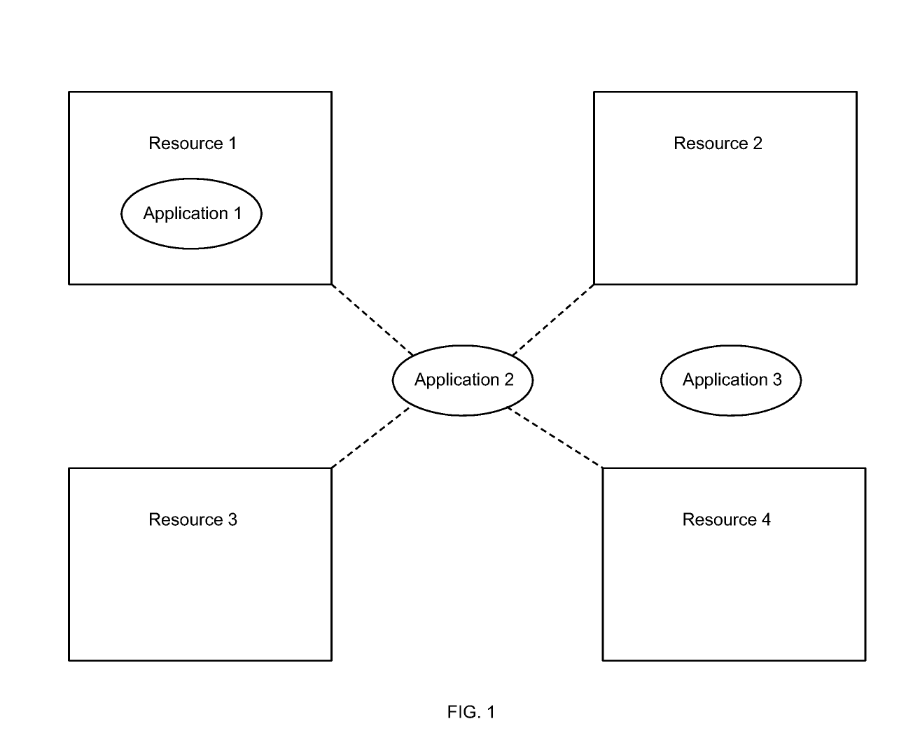

FIG. 1 illustrates a graphical user interface display according to an embodiment of the invention. A collection of blade servers are available for a task which can be distributed across multiple systems, e.g., crawling the web, implementation of an application server (e.g., IBM WebSphere®) stream application, searching emails for SPAM. Each rack of blades is represented by a rectangle, i.e., Resource 1, 2, 3, and 4 each represent a rack of blades. The administrator has 3 applications to allocate among the racks of blades. For example, Application 1 is crawling the web, Application 2 is a streaming application, and Application 3 is an anti-spam email application (searches stored emails to delete SPAM).

The administrator can move the representations (i.e., ovals) by grabbing the representation with the mouse and dragging the representation. In this example, the administrator determines that Application 1 should obtain 100% of its CPU from rack_of-blades_1, Application 2 should obtain 25% of its CPU usage from each of the 4 rack_of_blades, and application 3 should obtain 50% of its CPU usage from rack_of_blades_3 and 50% from rack_of_blades_4.

FIG. 1 illustrates the percentage consumption of resources from the application's point of view. For those skilled in the art, it is clear that a calculation can be made from the point of view of the resource which may be rendered in a variety of methods, e.g., hovering over the resource, a table, an informational text field within the resource representation. For this example, it could convey that resource 1 was expending 50% of its CPU on Application 1 and 50% on Application 2.

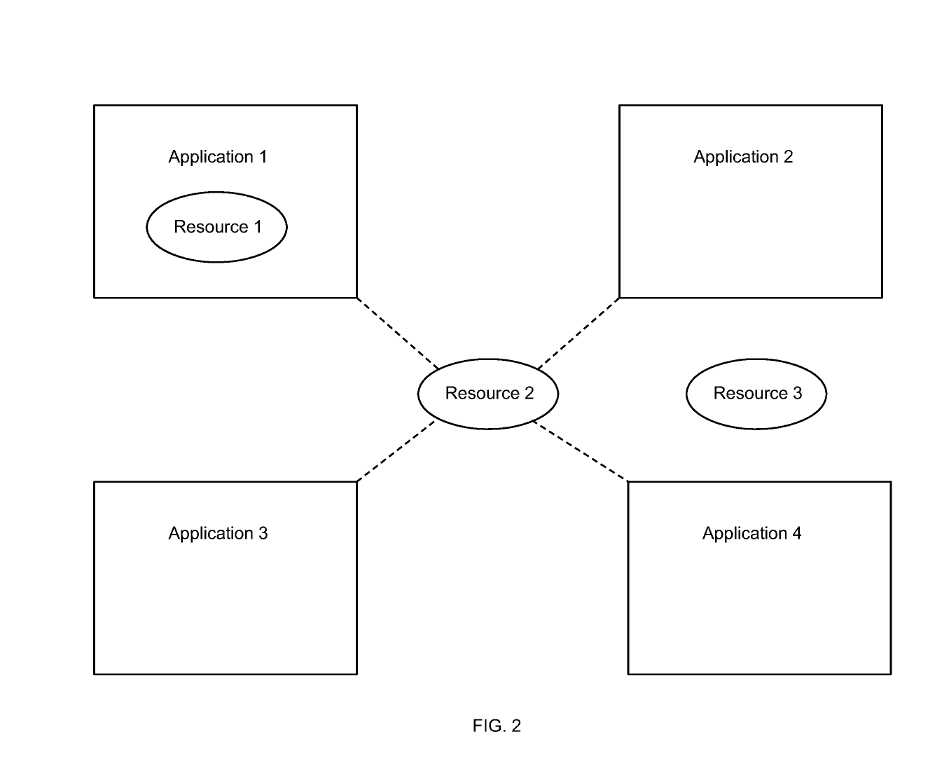

In this example, the applications were under control such that the administrator could allocate the application to the CPU via movement of the application representations. In another embodiment, the applications are represented by rectangles and the resources (i.e., rack_of_blades) are represented by the ovals, wherein movement of the ovals by the administrator determines the allocation of the resources to the application. Using FIG. 2 as an example, 100% of rack_of_blades_1 is used for Application 1, 25% of rack_of_blades_2 is used for each of the 4 applications, and 50% of rack_of_blades_3 is used for Application 3 and 50% of rack_of_blades_3 is used for Application 4.

In another embodiment of the invention, a mouse cursor is the symbol for the resource and the applications are represented by objects (e.g., rectangles). Thus, when the cursor moves from one application to another, it has the same effect as moving the symbol. In yet another embodiment, when the mouse cursor/pointer is moved over an object, an options dialog is displayed with multiple options (e.g., give 25% CPU, 50% CPU, 75% CPU, max CPU) and the user can select the desired allocation of resource. In still another embodiment, the system selectively dims objects on the GUI. For example, an application object is dimmed on the GUI as the symbol moves away from the object.

In at least one embodiment of the invention, a rules engine defines minimum application requirements or business requirements. If the user moves an object which results in taking resources away, the system pops up a warning indicating that the action will break the business rule (e.g., payroll processing by 5 PM today) in order to complete the action.

In another embodiment, grouping(s) of applications are represented via a selection mechanism (e.g., a wire-frame circle around nearby applications, a tagging system of applications, etc). For example, a user has a set of applications/processes associated with a software build process and another set of applications/processes associated with administrative tools (e.g., email and instant messaging). The user starts the software build processes, but moves the symbol to his email/IM group of applications so he can read through his daily emails and respond to messages from colleagues. As he does so, the CPU(s) and priorities allocated to the software build processes are decreased and increased for the email and IM applications. If the user leaves his machine to go to a meeting, he may move the symbol on top of the software build processes to give them full control of the CPU(s) and the highest processing priorities. In another embodiment, computing resources are automatically reallocated based on inactivity. For instance, if the user's administrative tools have been idle for more than 20 minutes, the CPU(s) and priorities allocated to the software build processes are increased and decreased for the email and IM applications.

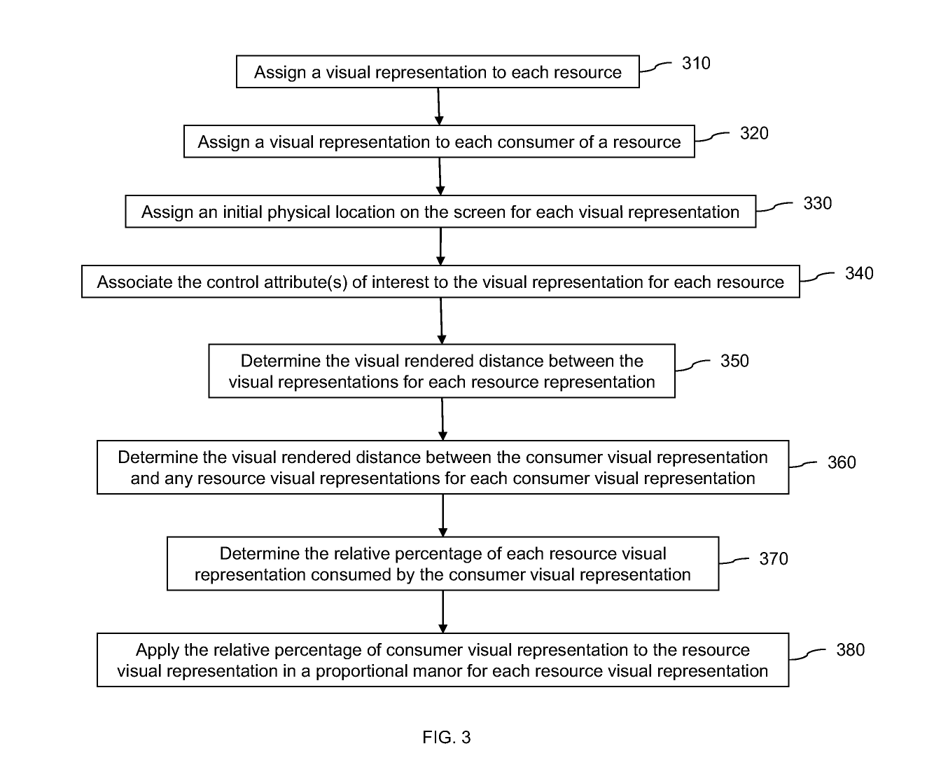

FIG. 3 illustrates a method for controlling IT resource behavior according to an embodiment of the invention. Each resource (e.g., processing rates) or collection of resources is assigned a visual representation 310, e.g., a specific shape and color. Each consumer of a resource (e.g., application) is assigned a visual representation, e.g., a specific shape and color 320. Each representation is assigned an initial physical location on the screen 330.

For each resource, the control attribute(s) of interest are associated to the visual representation 340. For example, if the resource is a processor, the CPU cycles are associated to the visual representation. If the resource is network link, then the link's transport capacity is associated to the visual representation. For each resource representation, the visual rendered distance between the representations is determined 350.

For each consumer representation, the visual rendered distance between the consumer representation and any resource representations is determined 360. Moreover, the relative percentage of each resource representation consumed by the consumer representation is determined 370 (e.g., using information from 350 and 360). For each resource representation, the relative percentage of consumer representation is applied to the resource representation in a proportional manor 380. If any representation is moved on the screen, then go to 360.

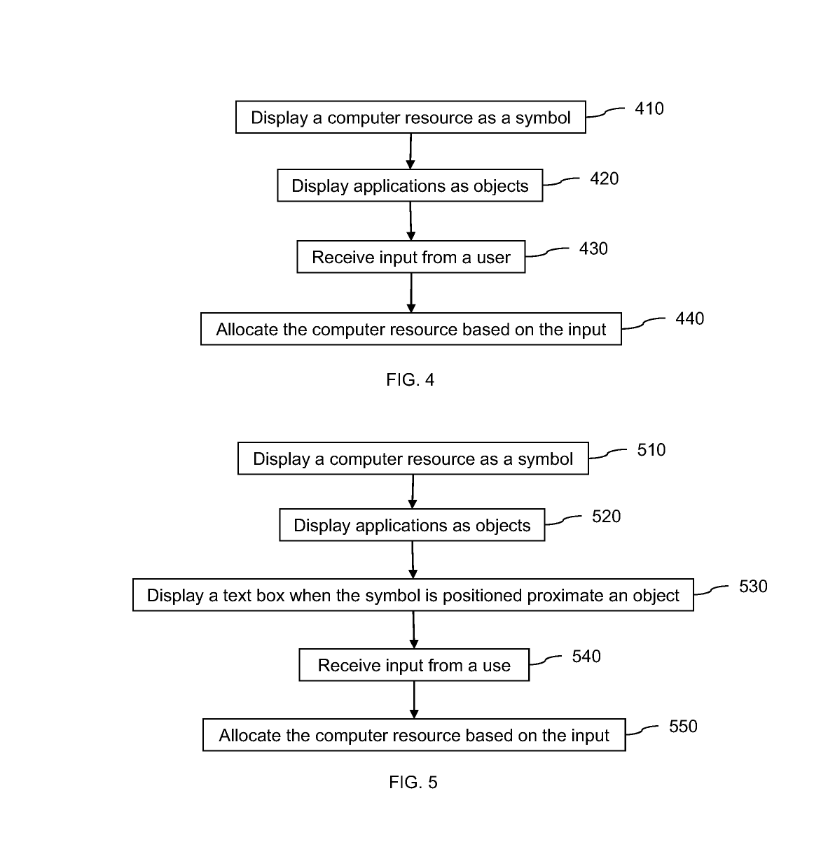

FIG. 4 is a flow diagram illustrating a method for controlling computing resources using visual positioning on a graphical user interface according to another embodiment of the invention. A computer resource is displayed as a symbol (also referred to herein as a “resource visual representation”) on the graphical user interface 410. The symbol can be represented by an icon, cursor, pointer, or shape. For instance, as illustrated in FIG. 2, Resource 1, Resource 2, and Resource 3 are displayed as ovals. The computer resources include CPU time, memory, hard disk space, network throughput, electrical power, processing priority, servers, audio output, video output, and/or processing rates.

Applications (e.g., tasks, jobs, web applications, word processing applications, database applications, etc.) are displayed as objects (also referred to herein as a “consumer visual representation”) on the graphical user interface 420. The objects can be represented by icons or shapes. For instance, as illustrated in FIG. 2, Application 1, Application 2, Application 3, and Application 4 are displayed as rectangles.

Input is received from a user 430, wherein the input includes movement of the symbol and/or movement of the objects on the graphical user interface. For instance, with reference to FIG. 2, the Resource 3 can be moved closer to either the Application 2 or the Application 4 using the user's mouse.

The computer resource is allocated with a processor based on the input 440. More specifically, more of the computer resource is allocated to a first application and less of the computer resource is allocated to a second application when the distance between the symbol and a first object representing the first application is reduced, and when the distance between the symbol and a second object representing the second application is increased. For example, with reference to FIG. 2, if the Resource 3 is moved upwards towards Application 2, more of the computer resource represented by the Resource 3 symbol (e.g., processing priority) is allocated to the application represented by the Application 2 object (e.g., a word processing application) and less of the computer resource represented by the Resource 3 symbol is allocated to the application represented by the Application 4 object (e.g., an MP3 player). Furthermore, more of the computer resource represented by the Resource 3 symbol is allocated to the application represented by the Application 1 object (e.g., web browser) and less of the computer resource represented by the Resource 3 symbol is allocated to the application represented by the Application 3 object (e.g., e-mail application).

In another example, with reference to FIG. 2, if the Resource 2 symbol is moved directly towards the left of the graphical user interface, more of the computer resource represented by the Resource 2 symbol (e.g., hard disk space) is allocated to the applications represented by the Application 1 and Application 3 objects, and less of the computer resource represented by the Resource 2 symbol is allocated to the applications represented by the Application 2 and Application 4 objects.

In at least one embodiment of the invention, the visual display (i.e., rendering) of an object is dimmed when the distance between the object and a symbol is increased. Thus, in the preceding example, the Application 2 object and Application 4 object are dimmed on the graphical user interface as the Resource 2 symbol is moved towards the left side of the graphical user interface.

In another embodiment, the allocating of the computer resource is further based on rules, wherein the rules define a minimum computer resource to be allocated to an application and/or a maximum computer resource to be allocated to an application. If the user input would result in a violation of a rule, the allocation of a resource to/from an application is disallowed and/or a message is sent to the user alerting the user of the rule violation. For example, if moving a resource X symbol away from an application Y object would violate a minimum threshold for the resource X in application Y, then an alert is sent to the user. In another example, if moving a resource Z symbol towards the application Y object would violate a maximum threshold for the resource Z in application Y, then the allocation of additional resource Z to application Y is disallowed.

FIG. 5 is a flow diagram illustrating a method for controlling computing resources according to another embodiment of the invention. A computer resource is displayed as a symbol on the graphical user interface 510; and, applications are displayed as objects on the graphical user interface 520. When the symbol is positioned proximate one of the objects, a text box is displayed 530, wherein the text box including computer resource allocation options for the object proximate the symbol. As used herein, the term proximate is intended to mean near, adjacent, contiguous, next to, close to, by, on, in, and/or in contact with.

In at least one embodiment of the invention, the computer resource allocation options include absolute measures of the computer resource to be allocated to the object proximate the symbol and/or relative measures of the computer resource to be allocated to the object proximate the symbol. In one embodiment, the computer resource allocation options include percentages of the computer resource to be allocated to the object proximate the symbol.

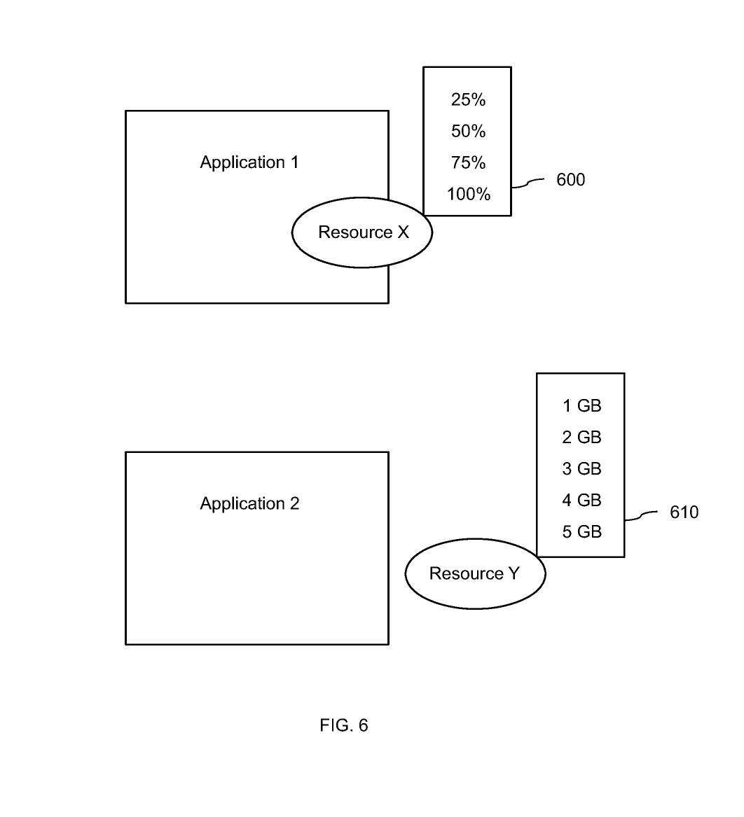

For example, as illustrated in FIG. 6, a text box 600 is displayed when a Resource X (e.g., CPU time) symbol is positioned on an Application 1 object; and, a text box 610 is displayed when a Resource Y symbol (e.g., memory) is positioned on an Application 2 object. The text box 600 includes computer resource allocation options: 25%, 50%, 75%, and 100%. The text box 610 includes computer resource allocation options: 1 GB, 2 GB, 3 GB, 4 GB, and 5 GB.

Input is received from a user 540, wherein the input includes selection of one of the computer resource allocation options. The computer resource is allocated with a processor based on the input from the user 550. Thus, for example, if the user selects the computer resource allocation option “50%” in text box 600, then half of the CPU time will be allocated to Application 1. If the user selects the computer resource allocation option “2 GB” in text box 610, then 2 GB of memory will be allocated to Application 2.

In another embodiment of the invention, computer resources are displayed as symbols on a graphical user interface; and applications are displayed as objects on the graphical user interface. Input is received from a user, wherein the input includes movement of an objects and/or movement of a symbol on the graphical user interface (e.g., a touch screen monitor).

The computer resources are allocated with a processor based on the input. Specifically, more of a first computer resource is allocated to an application represented by an object when the distance between a symbol representing the first computer resource and the object is decreased. For example, with reference to FIG. 2, if the Resource 2 symbol is moved towards the Application 4 object (i.e., down and/or towards the right side of the graphical user interface), then more of the Resource 2 would be allocated to the Application 4.

Furthermore, less of a second computer resource is allocated to the application represented by the object when a distance between a symbol representing the second computer resource and the object is increased. For example, with reference to FIG. 2, if the Resource 3 symbol is moved away from the Application 4 object (i.e., up and/or towards the left side of the graphical user interface), then less of the Resource 3 would be allocated to the Application 4.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for loadbalancing between clouds).

A cloud computing environment is service oriented with a focus on statelessness, low coupling, modularity, and semantic interoperability. At the heart of cloud computing is an infrastructure comprising a network of interconnected nodes.

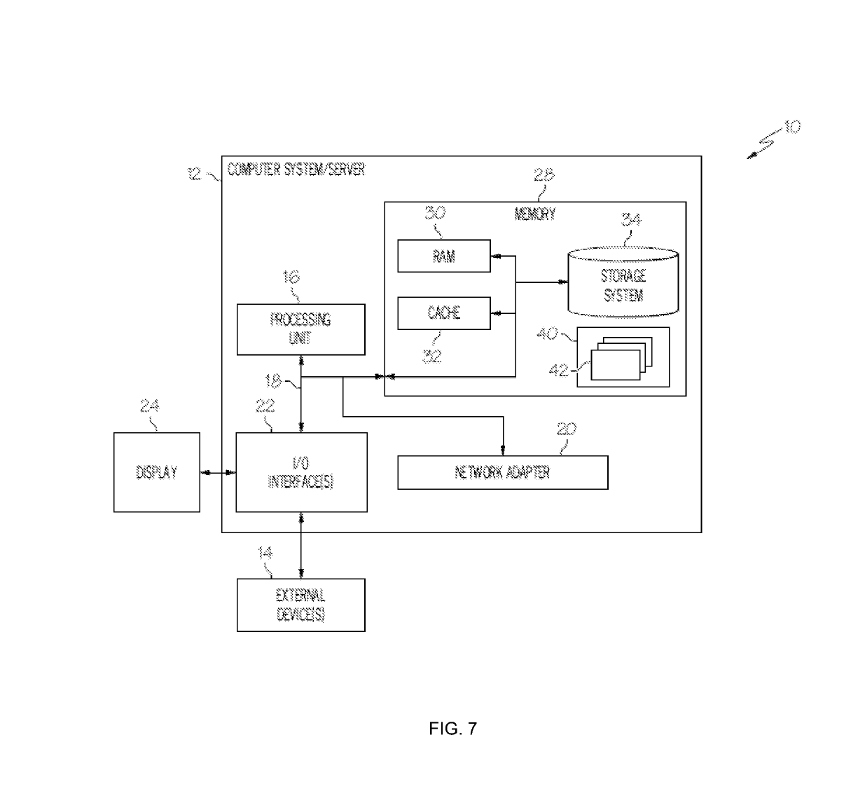

Referring now to FIG. 7, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 7, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

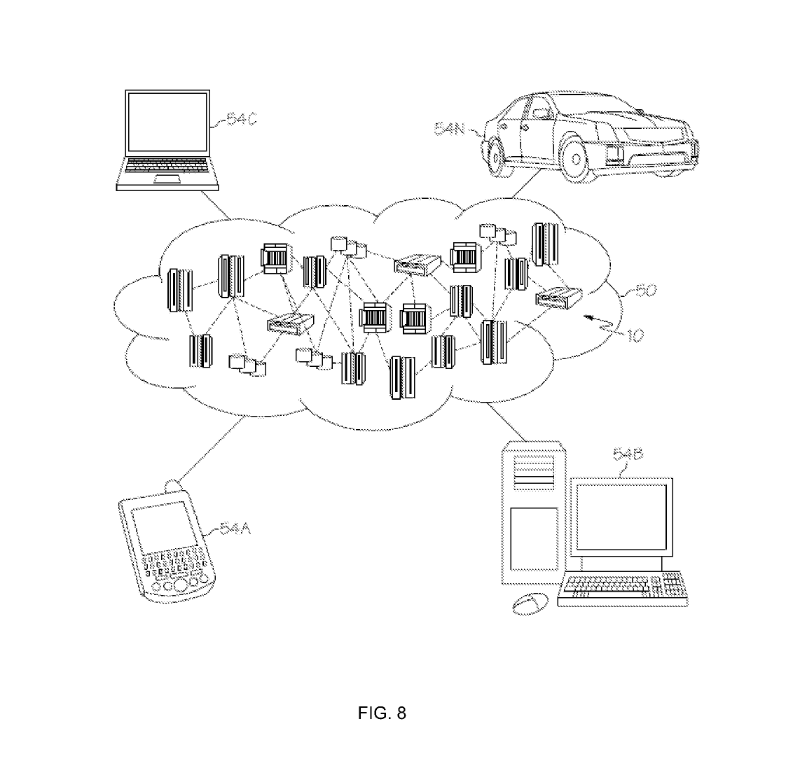

Referring now to FIG. 8, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 8 are intended to be illustrative only and that computing nodes 10 and cloud computing environment 50 can communicate with any type of computerized device over any type of network and/or network addressable connection (e.g., using a web browser).

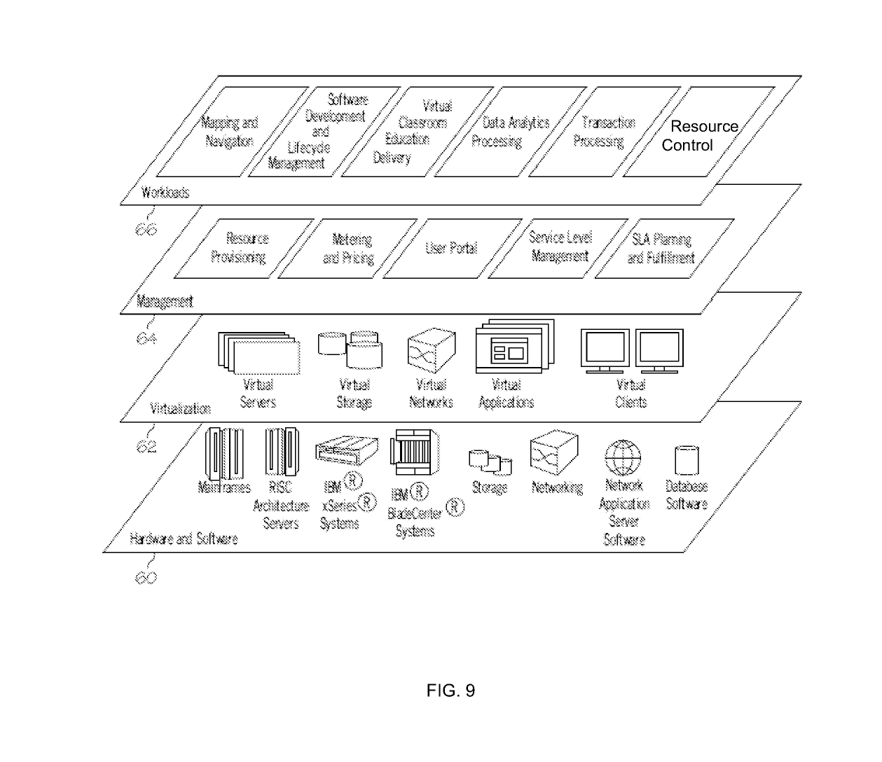

Referring now to FIG. 9, a set of functional abstraction layers provided by cloud computing environment 50 (FIG. 8) is shown. It should be understood in advance that the components, layers, and functions shown in FIG. 9 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and control of IT resource behavior.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in at least one computer readable medium having computer readable program code embodied thereon.

Any combination of at least one computer readable medium may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having at least one wire, portable computer diskette, hard disk, random access memory (RAM), read-only memory (ROM), erasable programmable read-only memory (EPROM or Flash memory), optical fiber, portable compact disc read-only memory (CD-ROM), optical storage device, magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of at least one programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute with the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

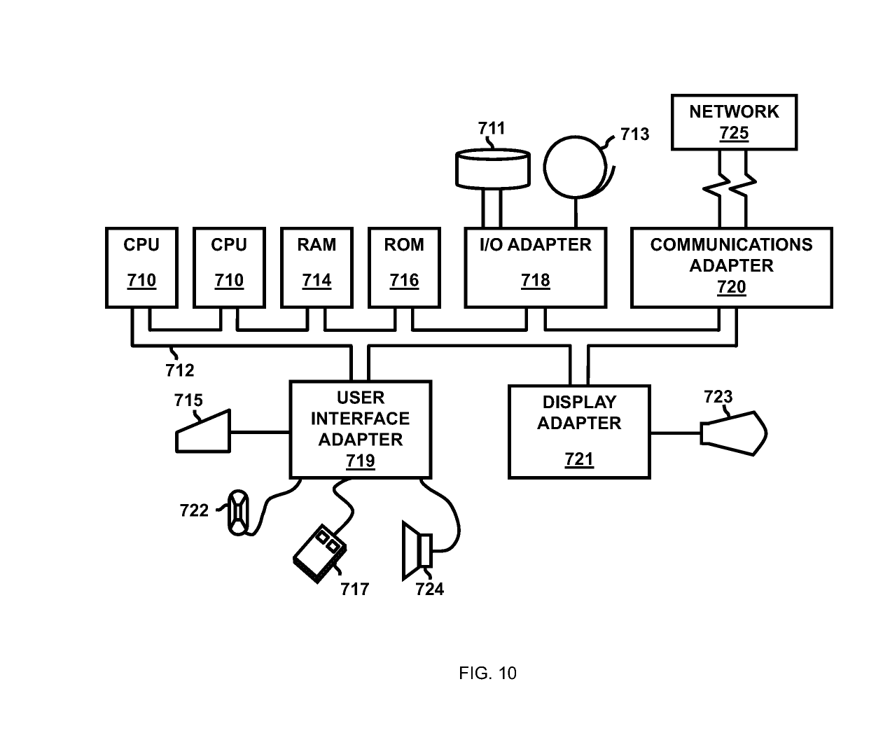

Referring now to FIG. 10, a representative hardware environment for practicing at least one embodiment of the invention is depicted. This schematic drawing illustrates a hardware configuration of an information handling/computer system in accordance with at least one embodiment of the invention. The system comprises at least one processor or central processing unit (CPU) 710. The CPUs 710 are interconnected with system bus 712 to various devices such as a random access memory (RAM) 714, read-only memory (ROM) 716, and an input/output (I/O) adapter 718. The I/O adapter 718 can connect to peripheral devices, such as disk units 711 and tape drives 713, or other program storage devices that are readable by the system. The system can read the inventive instructions on the program storage devices and follow these instructions to execute the methodology of at least one embodiment of the invention. The system further includes a user interface adapter 717 that connects a keyboard 715, mouse 717, speaker 724, microphone 722, and/or other user interface devices such as a touch screen device (not shown) to the bus 712 to gather user input. Additionally, a communication adapter 720 connects the bus 712 to a data processing network 725, and a display adapter 721 connects the bus 712 to a display device 723 which may be embodied as an output device such as a monitor, printer, or transmitter, for example.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the root terms “include” and/or “have”, when used in this specification, specify the presence of stated features, integers, steps, operations, elements, and/or components, but do not preclude the presence or addition of at least one other feature, integer, step, operation, element, component, and/or groups thereof.

The corresponding structures, materials, acts, and equivalents of all means plus function elements in the claims below are intended to include any structure, or material, for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for controlling computing resources using visual positioning on a graphical user interface, said method comprising:
displaying a computer resource as a symbol on the graphical user interface;
displaying applications as objects on the graphical user interface;
receiving input from a user, the input including at least one of movement of the symbol and movement of at least one of the objects on the graphical user interface;
allocating the computer resource with a processor based on the input, said allocating of the computer resource including allocating more of the computer resource to at least one first application of the applications and less of the computer resource to at least one second application of the applications when a distance between the symbol and at least one first object representing the at least one first application is reduced and when a distance between the symbol and at least one second object representing the at least one second application is increased.

2. The method according to claim 1, wherein the computer resource includes at least one of CPU time, memory, hard disk space, network throughput, electrical power, processing priority, servers, audio output, video output, and processing rates.

3. The method according to claim 1, wherein said allocating of the computer resource is further based on rules, wherein the rules define at least one of:
a minimum computer resource to be allocated to the at least one first application;
a maximum computer resource to be allocated to the at least one first application;
a minimum computer resource to be allocated to the at least one second application; and
a maximum computer resource to be allocated to the at least one second application

4. The method according to claim 1, further comprising at least one of dimming the display of the at least one first object when the distance between the at least one first object and the symbol is increased and dimming the display of the at least one second object when the distance between the at least one second object and the symbol is increased.

5. The method according to claim 1, further comprising:
displaying a text box when the symbol is positioned proximate one of the objects, the text box including computer resource allocation options for the object proximate the symbol; and
allocating the computer resource based on selection of a computer resource allocation option in the text box by the user.

6. The method according to claim 5, wherein the computer resource allocation options include percentages of the computer resource to be allocated to the object proximate the symbol.

7. The method according to claim 5, wherein the computer resource allocation options include at least one of:
absolute measures of the computer resource to be allocated to the object proximate the symbol; and
relative measures of the computer resource to be allocated to the object proximate the symbol.

8. A method for controlling computing resources using visual positioning on a graphical user interface, said method comprising:
displaying a computer resource as a symbol on the graphical user interface;
displaying applications as objects on the graphical user interface;
displaying a text box when the symbol is positioned proximate one of the objects, the text box including computer resource allocation options for the object proximate the symbol;
receiving input from a user, the input including selection of one of the computer resource allocation options; and
allocating the computer resource with a processor based on the input from the user.

9. The method according to claim 8, wherein the computer resource allocation options include percentages of the computer resource to be allocated to the object proximate the symbol.

10. The method according to claim 8, wherein the computer resource allocation options include at least one of:
absolute measures of the computer resource to be allocated to the object proximate the symbol; and
relative measures of the computer resource to be allocated to the object proximate the symbol.

11. The method according to claim 8, wherein the computer resource includes at least one of CPU time, memory, hard disk space, network throughput, electrical power, processing priority, servers, audio output, video output, and processing rates.

12. The method according to claim 8, wherein said allocating of the computer resource is further based on rules, wherein the rules define at least one of a minimum computer resource to be allocated to at least one of the applications and a maximum computer resource to be allocated to at least one of the applications.

13. The method according to claim 8, further comprising dimming a display of an object of the objects when a distance between the object and the symbol is increased.

14. A method for controlling computing resources using visual positioning on a graphical user interface, said method comprising:
displaying the computer resources as symbols on a graphical user interface;
displaying applications as objects on the graphical user interface;
receiving input from a user, the input including at least one of movement of at least one of the objects and movement of at least one of the symbols on the graphical user interface;
allocating the computer resources with a processor based on the input, said allocating of the computer resources including:
allocating more of at least one first computer resource of the computer resources to an application represented by an object when a distance between a symbol representing the at least one first computer resource and the object is decreased, and
allocating less of at least one second computer resource of the computer resources to the application represented by the object when a distance between a symbol representing the at least one second computer resource and the object is increased.

15. The method according to claim 14, wherein the computer resources include at least one of CPU time, memory, hard disk space, network throughput, electrical power, processing priority, servers, audio output, video output, and processing rates.

16. The method according to claim 14, wherein said allocating of the computer resources is further based on rules, wherein the rules define at least one of minimum computer resources to be allocated to the application represented by the object and maximum computer resources to be allocated to the application represented by the object.

17. The method according to claim 14, further comprising:
displaying a text box when the object is positioned proximate one of the symbols, the text box including computer resource allocation options for the symbol proximate the object; and
allocating the computer resources based on selection of a computer resource allocation option in the text box by the user.

18. The method according to claim 17, wherein the computer resource allocation options include percentages of the computer resources to be allocated to the symbol proximate the object.

19. The method according to claim 17, wherein the computer resource allocation options include at least one of:
absolute measures of the computer resources to be allocated to the symbol proximate the object; and
relative measures of the computer resources to be allocated to the symbol proximate the object.

20. The method according to claim 14, further comprising dimming the display of the at least one second computer resource when the distance between the symbol representing the at least one second computer resource and the object is increased.
